(19) United States
(12) Patent Application Publication
(10) Pub. No.: US 2019/0005636 A1
(43) Pub. Date: Jan. 3, 2019

(54) METHODS AND SYSTEMS FOR OPERATING AN APPARATUS THROUGH AUGMENTED REALITY

(71) Applicant: Guangdong Virtual Reality Technology Co., Ltd., Shenzhen City (CN)

(72) Inventors: JINGWEN DAI, Shenzhen City (CN); JIE HE, Shenzhen City (CN)

(21) Appl. No.: 15/657,188

(22) Filed: Jul. 23, 2017

(30) Foreign Application Priority Data
Jun. 30, 2017 (CN) PCT/CN2017/091261

(51) Int. Cl. G06T 7/00; G02B 27/01; G06F 17/30

(52) U.S. Cl. CPC G06T 7/0002; G02B 27/0172; G02B 27/0176; G02B 2027/0192; G02B 2027/0178; G02B 2027/0138; G06F 17/30244

(57) ABSTRACT

A system for operating an apparatus through augmented reality is provided. The system includes an image capture unit, an image processing unit, a display, a control device and a control center. The image capture unit captures an image of a real-world environment of a user. The image processing unit processes the captured image to identify a target apparatus. The display is adapted for viewing by the user, which displays to the user an AR information image for the target apparatus. The control device receives from the user an operational input for the target apparatus and transmits the operational input. The control center receives the transmitted operational input and sends an operational signal to the target apparatus. The method is also provided. The system and the method for operating an apparatus through augmented reality can intuitive controls and operations of an apparatus while providing its status and related information.

### FIELD OF THE INVENTION

The present disclosure generally relates to methods and systems for intuitive operation through augmented reality, and more particularly, to methods and systems for controlling and setting up an apparatus through an augmented reality image for the apparatus.

### BACKGROUND OF THE INVENTION

A user generally needs to be in physical proximity to an apparatus in order to operate the apparatus, such as obtaining the status of the apparatus or setting up operational parameters for the apparatus. It takes time to physically approach different apparatus units and respectively operate their user interfaces. Some existing central control methods may access status and manage operations of multiple apparatus units through a central control unit which is connected to all apparatus units. However, it requires an easy-to-use interface and an integrated control and management system. It can be challenging to design a common, user friendly interface for various types of apparatus units and different users.

Augmented reality (AR) is a live direct or indirect view of a physical, real-world environment whose elements are augmented or supplemented by computer-generated input such as sound, images, graphics, or data. A user can receive supplemented information through AR images while observing the real-world environment. AR provides an intuitive view supplemented with additional information about an apparatus. However, intuitive controls and operations of an apparatus are rarely disclosed and discussed.

Therefore, methods and systems are needed to provide improved intuitive control and operation of apparatus while providing its status and related information. The disclosed methods and systems address one or more of the problems set forth above and/or other problems in the prior art.

### SUMMARY OF THE INVENTION

In accordance with an aspect, the present invention provides a system for operating an apparatus through augmented reality (AR). The system includes an image capture unit, an image processing unit, a display, a control device and a control center. The image capture unit captures an image of a real-world environment of a user. The image processing unit processes the captured image to identify a target apparatus. The display is adapted for viewing by the user, which displays to the user an AR information image for the target apparatus. The control device receives from the user an operational input for the target apparatus and transmits the operational input. The control center receives the transmitted operational input and sends an operational signal to the target apparatus.

In accordance with another aspect, the present invention provides a method for operating an apparatus through augmented reality (AR). The method includes obtaining an image of a real-world environment; identifying a target apparatus in the obtained image; displaying, to a user, an AR information image for the target apparatus; receiving an operational input for the target apparatus; and sending an operational signal to the target apparatus.

In accordance with an still another aspect, the present invention provides a non-transitory computer-readable medium storing instructions which, when executed, cause at least one processor to perform operations for operating an apparatus through augmented reality (AR). The operations includes obtaining an image of a real-world environment; identifying a target apparatus in the obtained image; displaying, to a user, an AR information image for the target apparatus; receiving an operational input for the target apparatus; and sending an operational signal to the target apparatus.

The system and the method for operating an apparatus through augmented reality (AR) can intuitive controls and operations of an apparatus while providing its status and related information.

### BRIEF DESCRIPTION OF THE DRAWINGS

The accompanying drawings, which are incorporated in and constitute a part of this specification, illustrate exemplary embodiments of the present disclosure, and together with the description, serve to explain the principles of the disclosure.

FIG. 1 is an exemplary system for intuitive operations through augmented reality, according to a disclosed embodiment.

FIG. 2 is an exemplary display of augmented reality images after receiving an operational input from a user, according to a disclosed embodiment.

FIG. 3 is an exemplary head-mounted display for intuitive operations through augmented reality, according to a disclosed embodiment.

FIG. 4 is an exemplary identity indicator for intuitive operations through augmented reality, according to a disclosed embodiment.

FIG. 5 is an exemplary camera for intuitive operations through augmented reality, according to a disclosed embodiment.

FIG. 6 is another exemplary camera for intuitive operations through augmented reality, according to a disclosed embodiment.

FIG. 7 is a block diagram of an exemplary image processing unit for intuitive operations through augmented reality, according to a disclosed embodiment.

FIG. 8 is an exemplary control center in an exemplary system architecture for intuitive operations through augmented reality, according to a disclosed embodiment.

FIG. 9 is an exemplary control device for intuitive operations through augmented reality, according to a disclosed embodiment.

FIG. 10 is a flow chart illustrating an exemplary processing flow for intuitive operations through augmented reality, according to a disclosed embodiment.

### DETAILED DESCRIPTION OF PREFERRED EMBODIMENTS

This description and the accompanying drawings that illustrate exemplary embodiments should not be taken as limiting. Various mechanical, structural, electrical, and operational changes may be made without departing from the scope of this description and the claims, including equivalents. In some instances, well-known structures and techniques have not been shown or described in detail so as not to obscure the disclosure. Similar reference numbers in two or more figures represent the same or similar elements. Furthermore, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

This disclosure generally relates to methods and systems for intuitively operating an apparatus through augmented reality. It is contemplated that a target apparatus may be a computer, a printer, a measuring instrument, a piece of equipment, a cooker, a washing machine, or any combination thereof. A target apparatus may include anything in a physical, real-world environment, such as an electrical apparatus, a piece of furniture, a facility, a pet, and even a human.

For a target apparatus that is capable of operating according to a user's instructions, it may need to be connected to a control center for receiving operational signals and/or information. While the target apparatus receives operational signals and/or information, it may execute users' instructions accordingly. For example, a computer, a printer, a measuring instrument, or a cooker is capable of executing certain operations according to users' instructions when it is connected to a control center. The control center sends control signals to instruct the target apparatus after receiving users' instructions. For a target apparatus that is not capable of executing any operation in response to users' instructions, users may query information about the target apparatus by intuitive operations through augmented reality when the target apparatus is included and recognizable in the system.

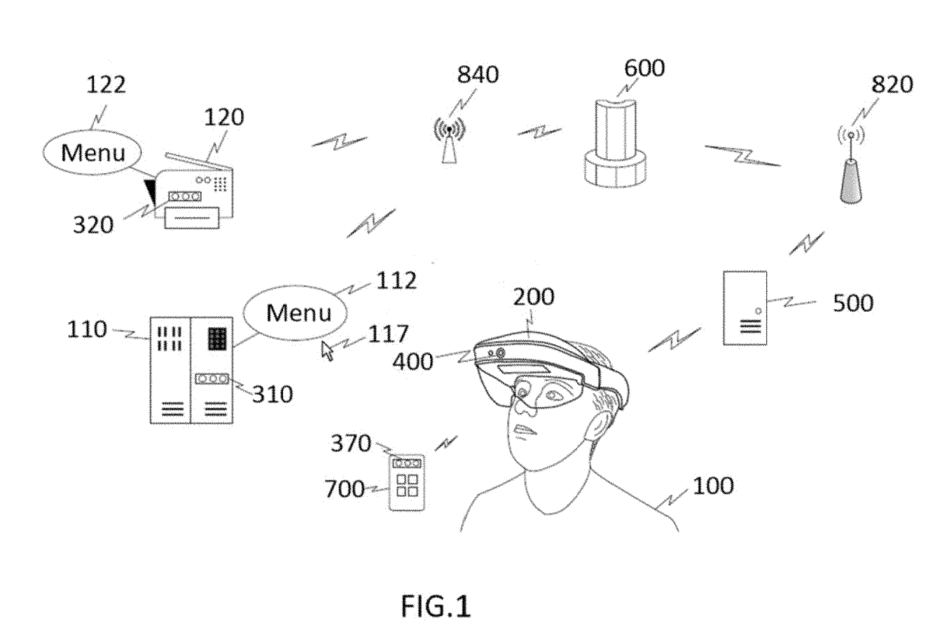

One aspect of the present disclosure is directed to a system for intuitive operations through augmented reality. FIG. 1 is an exemplary system for intuitive operations through augmented reality, according to a disclosed embodiment. The system comprises a display viewable by a user 100, such as a head mounted display (HMD) 200, an image processing unit 500, a control center 600, and a control device 700. In addition, in the figure, a computer 110 and a printer 120 are exemplary real-world target apparatus units to be observed and operated through augmented reality. Computer 110 and printer 120 include identity indicators 310 and 320 respectively. Computer 110, printer 120, and their respective identity indicators 310 and 320 are connected to control center 600 through a wireless access point 840.

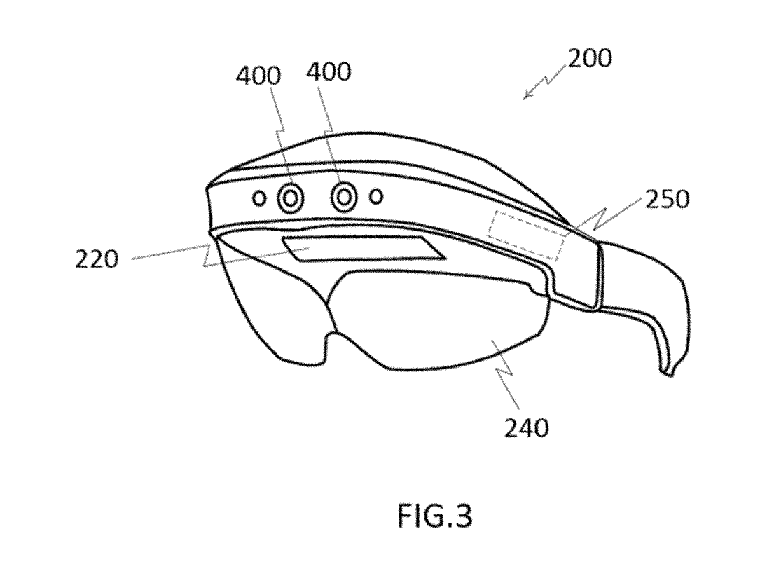

User 100 wears HMD 200 and observes computer 110 and printer 120 through HMD 200. HMD 200 includes a camera 400 that captures images of what user 100 sees. These images are viewed through a beam splitter 240 of HMD 200 (shown in FIG. 3). Beam splitter 240 is an optical device that renders a projected image as a display and overlays an actual image viewed by the user with the projected image. HMD 200 is connected to image processing unit 500 through wireless communications, to be described in more detail below and receives, via camera 400, indicator signals transmitted from identity indicator 310 and 320. After camera 400 takes images and/or receives indicator signals, HMD 200 sends these images and indicator signals to image processing unit 500 for further processing.

After receiving images and indicator signals, image processing unit 500 identifies and recognizes one or more real-world target apparatus units, for example, computer 110 and printer 120, based on the received images and indicator signals. Image processing unit 500 is further connected to control center 600 through a wireless access point 820, as shown in the figure. Image processing unit 500 then sends an identity of the target apparatus to control center 600 to retrieve information about the target apparatus. For example, image processing unit 500 sends identities of computer 110 and printer 120 to control center 600 through wireless connection provided by wireless access point 820.

After receiving the identity of the target apparatus, control center 600 looks up the information about the target apparatus in its database based on the received identity of the target apparatus, and sends the database information regarding the target apparatus to image processing unit 500. Image processing unit 500 then sends the information to HMD 200. HMD 200 displays an AR information image on beam splitter 240 based on the received information. User 100 sees through beam splitter 240 the target apparatus augmented with the information about the target apparatus. In FIG. 1, for example, user 100 sees computer 110 augmented with an AR information image 112 when user 100 sees through beam splitter 240 of HMD 200.

User 100 may use a control device 700 to operate the target apparatus. Control device 700 includes an identity indicator 370 as well. Through a similar identification process described above, control device 700 is identifiable while being viewed through HMD 200. In AR images, an AR pointer 117 may be used to represent control device 700 and present its position in AR images. AR pointer 117 moves correspondingly in AR images while user 100 moves control device 700. When user 100 moves control device 700 to let AR pointer 170 overlap with an AR information image 112, user 100 may press a button of control device 700 to express his operational input to the target apparatus or specifically to the overlapped AR information.

Upon receiving the operation input for the target apparatus from user 100, control device 700 sends an input signal containing the operational input to HMD 200. HMD 200 may display another AR image in response to user's 100 operational input. For example, after user 100 presses a button of control device 700 when AR pointer 117 overlaps with computer 110 or its AR information image 112, HMD 200 displays another AR image showing available operational menu for user 100. In some embodiments, HMD 200 may send a signal containing the received operational input to control center 600 to query further information corresponding to the received operational input. HMD 200 may display another AR image showing updated information corresponding to the received operational input after HMD 200 receives the updated information from control center 600.

In some embodiments, HMD 200 may send an operational signal to the target apparatus through control center 600. For example, HMD 200 sends an operational signal to control center 600 through image processing unit 500 after receiving the operational input from user 100. Control center 600 recognizes that the target apparatus, computer 110, is under its control, and sends a corresponding control signal to instruct computer 110 to operate according to the operational signal from HMD 200.

In FIG. 1, communications among HMD 200, image processing unit 500, control center 600, and control device 700 may be implemented through a wireless connection, such as Bluetooth, Wi-Fi, and cellular (e.g., GPRS, WCDMA, HSPA, LTE, or later generations of cellular communication systems) communications, or a wired connection, such as a USB line or a Lightning line. In addition to communications through Wi-Fi access point 820 and 840 as shown in the figure, other communication technologies may be used to implement connections between these apparatus units.

For example, HMD 200 and control device 700 may be directly connected through a Wi-Fi Direct technology, which does not need an access point. For another example, image processing unit 500 and control center 600 may be directly connected through an LTE Device-to-Device technology, which does not need an evolved node B (eNB) that is required in a traditional cellular communication system. In some embodiments, communications among HMD 200, image processing unit 500, control center 600, and control device 700 may be implemented through a wired connection. For example, universal serial bus (USB) lines, Lightning lines, or Ethernet cables may be used to implement connections among these apparatus units.

Communications between real-world target apparatus units and control center 600 may be implemented in similar ways as described above for the communications among HMD 200, image processing unit 500, control center 600, and control device 700. The communication units of these apparatus units carry out these communications as will be described in more detail below. In contrast, identification and positioning of a target apparatus and/or a control device, which includes an identity indicator, in an augmented reality environment are carried out through indicator signals.

For example, after receiving indicator signals transmitted from identity indicator 310 of computer 110, HMD 200 with the assistance of image processing unit 500 and/or control central 600 identifies computer 110 as a target apparatus and its position in the augmented reality environment based on the received indicator signals. Indicator signals may include one or more light signals, flash rates of the light signals, and wavelengths the light signals from an identity indicator.

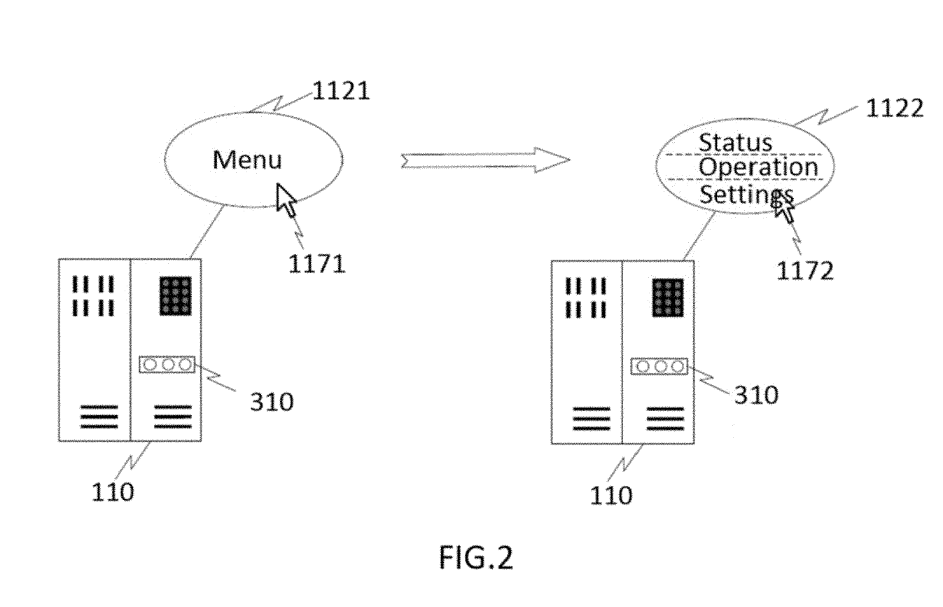

FIG. 2 is an exemplary display of augmented reality images after receiving an operational input from user 100, according to a disclosed embodiment. When user 100 moves control device 700 to let an AR pointer 1171 overlap with an AR information image 1121 and presses a button of control device 700, HMD 200 may display another AR image 1122 showing several operational options for user 100 to select. For example, after receiving an operational input, HMD 200 displays AR image 1122 including 1) Status, 2) Operations, and 3) Setting options for user 100 to select. User 100 may further move control device 700 to let AR pointer 1172 overlap with Setting of AR image 1122 and press a button of control device 700 again to enter into a setting menu of computer 110. HMD 200 may further display the setting menu for user 100 to select.

For another example, user 100 may move AR pointer 1172 to overlap with Status in AR image 1122 and press a button of control device 700. After receiving the operational input, HMD 200 may display the status of computer 110. When HMD 200 does not have corresponding information to display, HMD 200 may send a signal to request information to control center 600. After receiving corresponding information from control center 600, HMD 200 displays the received information in an updated AR image for user 100.

In another example, user 100 may move control device 700 to let AR pointer 1172 overlap with Power Off (not shown) in an AR image of computer 110 and press a button of control device 700. After receiving such an operational input corresponding to power off computer 110, HMD 200 sends an operational signal containing an instruction to power off computer 110 to control center 600. Control center 600 may then send the operational signal to computer 110 through its signaling between control center 600 and computer 110. When receiving the operational signal from control center 600, computer 110 may switch off itself accordingly. If computer 110 has any unfinished tasks, computer 100 may respond to control center 600 that it is unable to power off before accomplishing certain tasks. Control center 600 may send a corresponding message to HMD 200. HMD 200 then displays the message in an AR image to let user 100 know that computer 110 is busy on certain tasks and cannot be switched off at this moment.

FIG. 3 is exemplary head-mounted display 200 for intuitive operations through augmented reality, according to a disclosed embodiment. HMD 200 includes an AR projector 220, beam splitter 240, a communication unit 250, and camera 400. AR projector 220 projects augmented images on beam splitter 240 for user. Augmented images may include descriptive information, status information, operational information, setting information about one or more real-world apparatus units, or any combination thereof, as well as system messages. User 100 sees through beam splitter 240 to allow user 100 to observe the real-world environment directly. When AR projector 200 projects augmented images on beam splitter 240, beam splitter 240 allows user 100 to see the real-world environment augmented with the projected images. For example, user 100 sees computer 110 augmented with AR information image 112 while viewing through beam splitter 240 of HMD 200, as shown in FIG. 1.

Communication unit 250 may include any appropriate type of hardware, such as integrated circuits and field programmable gate arrays, or software, such as a set of instructions, a subroutine, or a function (i.e. a functional program) executable on a processor or controller, to carry out the following communication operations. Communication unit 250 includes modulation and demodulation subunits (i.e. a modem) that modulate and demodulate electric or radio signals for data transmission and reception. For example, communication unit 250 may include a Wi-Fi modem that transmits and receives data to and from image processing unit 500 through a Wi-Fi Direct technology. For another example, communication unit 250 may include an LTE modem that transmits and receives data to and from control center 600 through an LTE Device-to-Device technology. In certain applications, communication unit 250 may employ infrared technology.

As another example, communication unit 250 may include a Wi-Fi modem that transmits and receives data from Wi-Fi access point 820 or 840. Access point 820 or 840 may be connected with any one of apparatus units in FIG. 1 and assist data transmissions between HMD 200 and these apparatus units. In some embodiments, communication unit 250 may include a modem for wired communications, such as Ethernet, USB, IEEE 1394, and Thunderbolt while the connection between HMD 200, image processing unit 500, control center 600, and/or control device 700 are through these wire lines.

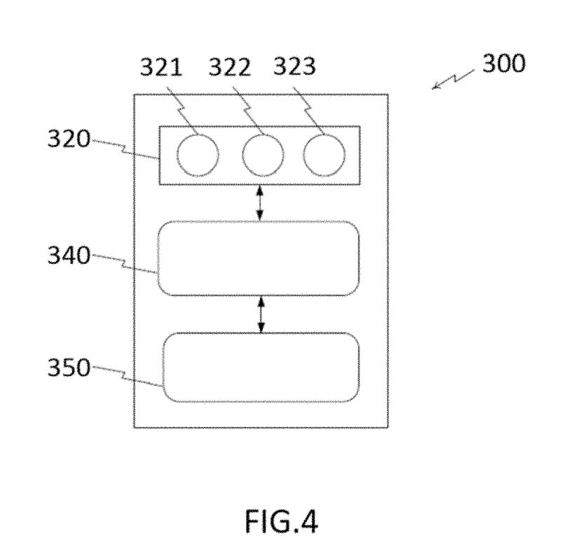

FIG. 4 is an exemplary identity indicator 300 for intuitive operations through augmented reality, according to a disclosed embodiment. Identity indicator 300 may be an individual device or embedded as identity indicator 310 of computer 110, identity indicator 320 of printer 120, and identity indicator 370 of control device 700. Identity indicator 300 includes indicator lights 320, a light controller 340, and a communication unit 350. Indicator lights 320 may include one or more light-emitting diode (LED) lights. Indicator lights 320 may emit visible and infrared lights through one or more LED devices. Emitted light signals from indicator lights 320 are used for identity identification and positioning in the augmented reality environment.

For example, indicator lights 320 of identity indicator 300 include LED lights 321, 322, 323 which emit visible light as indicator signals. For another example, LED lights 321, 322, 323 may emit and flash at different rates, constituting another kind of indicator signals for identity identification and/or positioning in the augmented reality environment. For another example, LED lights 321, 322, 323 may emit light of various wavelengths constituting yet another kind of indicator signals for identity identification and/or positioning in the augmented reality environment.

Light controller 340 may include any appropriate type of hardware, such as integrated circuits and field programmable gate arrays, or software, such as a set of instructions, a subroutine, or a function (i.e. a functional program) executable on a processor or controller, to carry out the following light control operations. Light controller 340 controls light emissions of indicator lights 320 to transmit indicator signals for identity identification and positioning. For example, light controller 340 may control one or more LED lights 321, 322, 323 to emit, emitting or flashing rates of LED lights 321, 322, 323, and/or wavelengths of lights emitted from LED lights 321, 322, and 323 as indicator signals. These indicator signals from an identity indicator may be unique and different from that of the other identity indicators.

For example, identity indicator 310 of computer 110 may have three LED lights while identity indicator 320 of printer 120 has two LED lights. Computer 110 and printer 120 then may be identified based on their respective three- and two-light indicator signals. Light controller 340 may reconfigure patterns of indicator signals for a target apparatus if needed. For example, when light controller 340 receives a reconfiguration instruction from control center 600 through communication unit 350, light controller 340 reconfigures its pattern of indicator signals to ensure the identity indicator's 300 distinctiveness among other identity indicators.

Communication unit 350 may include any appropriate type of hardware, such as integrated circuits and field programmable gate arrays, or software, such as a set of instructions, a subroutine, or a function (i.e. a functional program) executable on a processor or controller, to carry out the following communication operations. Communication unit 350 includes modulation and demodulation subunits (i.e. a modem) that modulate and demodulate electric or radio signals for data transmission and reception. For example, communication unit 350 may include a Wi-Fi modem that transmits and receives identity data to and from HMD 200 through a Wi-Fi Direct technology.

As another example, communication unit 350 may include an LTE modem that transmits and receives identity data to and from control center 600 through an LTE Device-to-Device technology. Yet for another example, communication unit 350 may include a Wi-Fi modem that transmits and receives identity data from Wi-Fi access point 820 or 840. Access point 820 or 840 may be connected any one of the system's apparatus units and real-world apparatus units in FIG. 1 and assist data transmissions between identity indicator 300 and these apparatus units. In some embodiments, communication unit 350 may include a modem for wired communications, such as Ethernet, USB, IEEE 1394, and Thunderbolt while the connection between identity indicator 300 and HMD 200, image processing unit 500, control center 600, and/or control device 700 are through these wire lines.

In some embodiments, communication unit 350 includes a communication interface (not shown) connected to a communication unit of a target apparatus or a control device. Communication unit 350 transmits and receives identity data to and from the above-mentioned apparatus units through the communication unit of the target apparatus or the control device. For example, communication unit 350 transmits and receives identity data to and from HMD 200 through a communication unit 750 of control device 700. For another example, communication unit 350 transmits and receives identity data to and from control center 600 through a communication unit of computer 110.

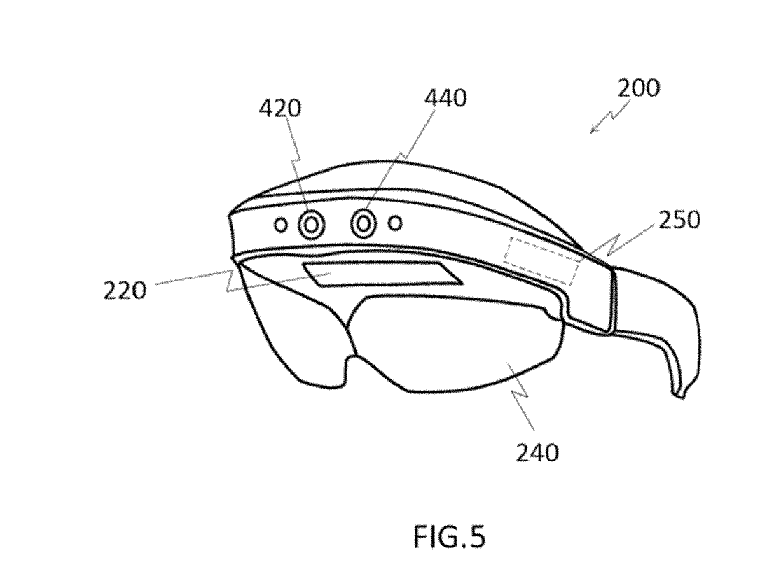

FIG. 5 is an illustration of exemplary cameras 420 and 440 on HMD 200 for intuitive operations through augmented reality, according to a disclosed embodiment. In FIG. 5, HMD 200 includes two cameras, for example, camera 420 and camera 440. Camera 420 and 440 are positioned on the top of HMD 200 and used to capture images of an environment that a user sees through beam splitter 240 of HMD 200. Cameras 420 and 440 send the captured images to HMD 200, and HMD 200 sends the received images to image processing unit 500 through communication unit 250.

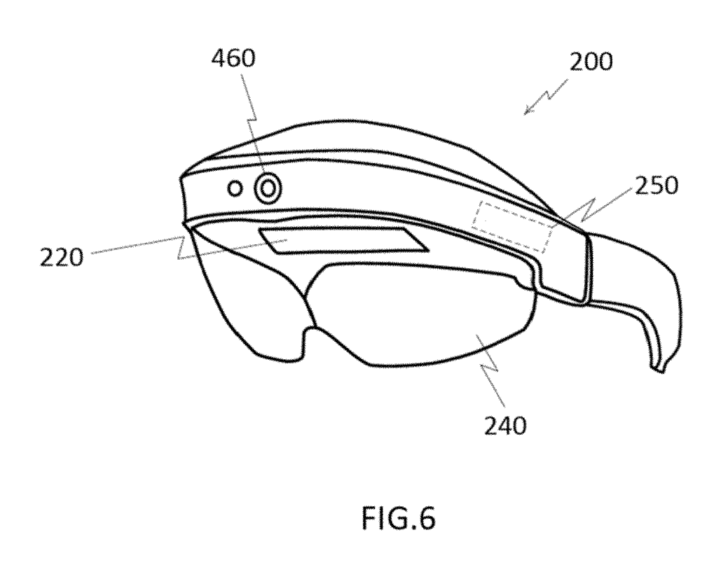

FIG. 6 is an illustration of an exemplary camera 460 on HMD 200 for intuitive operations through augmented reality, according to a disclosed embodiment. In FIG. 6, HMD 200 includes only a single camera 460. Camera 460 is positioned at the top of HMD 200 and is used to capture images of an environment that a user sees through beam splitter 240 of HMD 200. Camera 460 sends the captured images to HMD 200 and HMD 200 sends the received images to image processing unit 500 through communication unit 250. In some embodiments, cameras 420 and 440 may be placed in another position of HMD 200 to capture images that are closer to what user 100 sees from HMD 200.

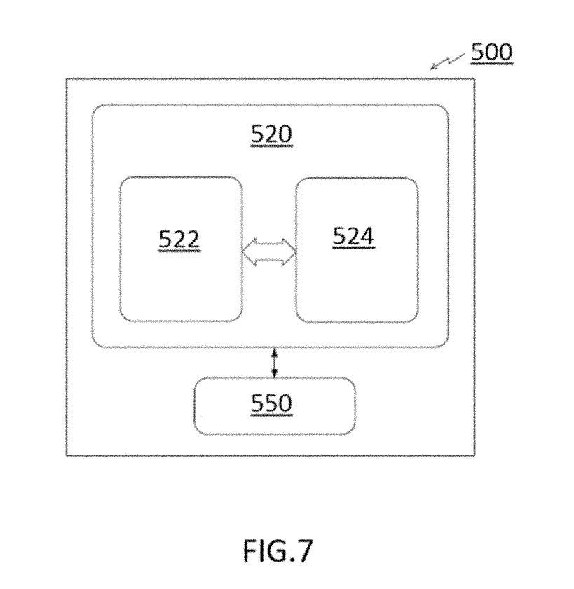

FIG. 7 is a block diagram of exemplary image processing unit 500 for intuitive operations through augmented reality, according to a disclosed embodiment. Image processing unit 500 includes an image processing module 520 and a communication unit 550. Image processing module 520 includes an identity detection module 522 and a coordinate calculation module 524.

Image processing module 520 may include any appropriate type of hardware, such as integrated circuits and field programmable gate arrays, or software, such as a set of instructions, a subroutine, or a function (i.e. a functional program) executable on a processor or controller, to carry out the following image processing operations. Image processing module 520 of image processing unit 500 receives images from HMD 200 through communication unit 550. Identity detection module 522 identifies one or more identities of identity indicators that are present in received images according to indicator signals transmitted from the one or more identity indicators. For example, identity detection module 522 identifies two different indicator signals from identity indicator 310 of computer 110 and identity indicator 320 of printer 120, respectively.

Identity detection module 522 may include any appropriate type of hardware, such as integrated circuits and field programmable gate arrays, or software, such as a set of instructions, a subroutine, or a function (i.e. a functional program) executable on a processor or controller, to carry out the following identity detection operations. After receiving indicator signals, identity detection module 522 identifies, for example, a number of light signals, a flash rate of the light signals, and/or wavelengths of the light signals from an identity indicator. Identity detection module 522 compares these parameters with that of potential target apparatus units. Image processing unit 500 may obtain these parameters of potential target apparatus units from control center 600. When identity detection module 522 identifies a set of parameters that does not match any set of parameters in image processing unit 500, image processing unit 500 may query control center 600 for information about the identified set of parameters.

In addition to identity detection, identity detection module 522 may also, at least roughly, identify the positions of target apparatus units on the images based on the positions of the received indicator signals on the images. After that, identity detection module 522 sends identified identities and positions of target apparatus units to coordinate calculation module 524.

Coordinate calculation module 524 may include any appropriate type of hardware, such as integrated circuits and field programmable gate arrays, or software, such as a set of instructions, a subroutine, or a function (i.e. a functional program) executable on a processor or controller, to carry out the following coordinate calculating operations. Coordinate calculation module 524 receives images and/or identified identities and positions of target apparatus units, and detects accurate positions of target apparatus units on the received images. For example, after receiving the identity of computer 110, coordinate calculation module 524 may detect the position of computer 110 in the images by matching a sample image of computer 100 in the received images to detect the position of computer 100.

In some embodiments, matching the sample image of computer 100 in the received images may include calculating match rates according to conventional template match methods, such as a squared difference method, a normalized squared difference method, a cross-correlation method, a normalized cross-correlation method, a correlation coefficient method, a normalized correlation coefficient method, or any combination thereof. The position of computer 110 in the received images is detected when a match rate with the template image of computer 110 is higher than a match threshold, such as 80%, 70%, or 60% of the self-match rate of the template image.

In some embodiments, coordinate calculation module 524 may detect the position of a target apparatus with reference to the position received from identity detection module 522. Coordinate calculation module 524 may match the sample image of computer 110 nearby the position received from identity detection module 522 to reduce computation complexity and/or the processing time.

In some embodiments, coordinate calculation module 524 may detect the position of a target apparatus in a three-dimensional coordinate, especially when camera 400 includes two cameras, such as cameras 420 and 440 in FIG. 5. Coordinate calculation module 524 may utilize different illumination directions between the images taken by two cameras to calculate the position of the target apparatus in a three-dimensional coordinate. After identifying the identity and the position of the target apparatus, image processing unit 500 may send them to control center 600 through communication unit 550.

Communication unit 550 may include any appropriate type of hardware, such as integrated circuits and field programmable gate arrays, or software, such as a set of instructions, a subroutine, or a function (i.e. a functional program) executable on a processor or controller, to carry out the following communication operations. Communication unit 550 includes modulation and demodulation subunits (i.e. a modem) that modulate and demodulate electric or radio signals for data transmission and reception. For example, communication unit 550 may include a Wi-Fi modem that transmits and receives the identity and the position of the target apparatus to and from control center 600 through a Wi-Fi Direct technology.

For another example, communication unit 550 may include an LTE modem that transmits and receives the identity and the position of the target apparatus to and from control center 600 through an LTE Device-to-Device technology. Yet for another example, communication unit 550 may include a Wi-Fi modem that transmits and receives the identity and the position of the target apparatus from Wi-Fi access point 820 or 840. For some applications, communication unit 550 may employ infrared technology.

Access point 820 or 840 may be connected any one of the system's apparatus units and the real-world apparatus units in FIG. 1 and assist data transmissions between image processing unit 550 and these apparatus units. In some embodiments, communication unit 550 may include a modem for wired communications, such as Ethernet, USB, IEEE 1394, and Thunderbolt while the connection between image processing unit 500 and HMD 200, control center 600, and/or control device 700 are through these wired lines.

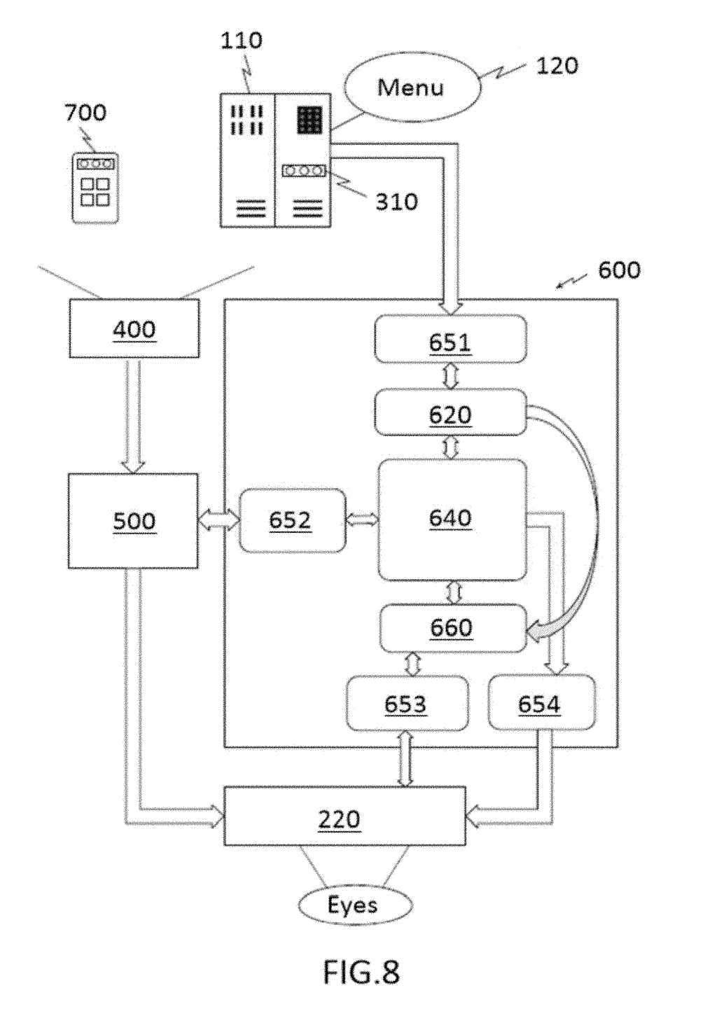

FIG. 8 is exemplary control center 600 in an exemplary system for intuitive operations through augmented reality, according to a disclosed embodiment. Control center 600 includes a database 620, a human-machine interaction (HMI) controller 640, an augmented reality (AR) image generator 660, a communication unit 651, a communication unit 652, a communication unit 653, and a communication unit 654. Control center 600 may include any appropriate type of hardware, such as integrated circuits and field programmable gate arrays, or software, such as a set of instructions, a subroutine, or a function (i.e. a functional program) executable on a processor or controller, to carry out the following control operations for intuitive operations through augmented reality. In some embodiments, control center 600 may include one or more storage units and one or more network servers to carry out the following control operations for intuitive operations through augmented reality.

Database 620 may include one or more types of memory devices or modules, such as registers in circuits, cache memories, random access memories (RAM), read only memories (ROM), disk memories, and cloud memories for storing information about target apparatus units. Information about target apparatus units may include at least identity information, sample images, descriptive information, status information, operational information, setting information, and so on.

Identity information about a target apparatus includes a unique indicator signal that may include, for example, a combination of one or more light signals, one or more flash rate of the one or more light signals, and one or more wavelengths of the one or more light signals. Sample images of a target apparatus may include one or more images of the target apparatus that are going to be used as templates in above template matching methods for detecting the position of the target apparatus.

Descriptive information about a target apparatus may include descriptions of the target apparatus' specification, functions, introduction, and so on. For example, descriptive information of computer 110 may include its computing capability, a number and the model of its central processing units (CPUs), and capacity of its main memory, hard disk drives, and/or cloud storages. Status information about a target apparatus may include operational status of the target apparatus. For example, status information of computer 110 may include its CPU loading, memory usage, accessibility of internet connection, access bandwidth of network connection, progress of executing tasks, and so on.

Operational information about a target status may include what kind of operations that is available for a user to instruct the target apparatus. For example, computer 100 may allow user 100 to instruct to turn on/off power, connect to a server, execute a certain task, and so on. These operations are collected as operational information and may be displayed in an AR image for user 100 to select.

Setting information about a target apparatus may include setting parameters that the target apparatus allow a user to decide. For example, computer 110 may allow user 100 to decide preference of graphic user interface, background execution of tasks, execution priority of tasks, deadlines of tasks, and so on. These setting parameters may be displayed in an AR image for user 100 to decide.

Human-machine interaction (HMI) controller 640 may include any appropriate type of hardware, such as integrated circuits and field programmable gate arrays, or software, such as a set of instructions, a subroutine, or a function (i.e. a functional program) executable on a processor or controller, to carry out the following control operations for intuitive operations through augmented reality. In some embodiments, HMI controller 640 may include one or more storage units and one or more network servers to carry out the following human-machine interactions for intuitive operations through augmented reality. HMI controller 640 controls the interactions between a user and displayed AR images. When the user inputs operational instructions through displayed AR information images, HMI controller 640 controls relevant units in FIG. 1 to accomplish the operation accordingly.

For example, user 100 may use control device 700 to provide an operational input for computer 100. As described above, image processing unit 500 may identify control device 700 and track its positions in AR information images. After receiving the identity of control device 700 and its positions in AR information images through communication unit 652, HMI controller 640 may instruct AR image generator 660 to generate pointer 117 (shown in FIG. 1) to represent control device 700 in AR images. When user 100 moves control device 700, HMI controller 640 controls AR image generator 660 to generate pointer 117 at an updated position on the AR image according to an updated position from image processing unit 500.

User 100 may move control device 700 to let pointer 1171 (shown in FIG. 2) overlap with AR information image 1121 and press a button of control device 700 as an operational input relating to AR information image 1121. HMI controller 640 may determine whether the position of pointer 1171 overlaps with AR information image 1121 according to an updated position of control device 700 when user 100 is pressing the button of control device 700. After determining an operational input relating to AR information image 1121, HMI controller 640 may send a corresponding signal including the operation input to the target apparatus, computer 110, through communication unit 651. Computer 110 may operate according to the operation input after receiving such signal from HMI controller 640.

In some embodiments, after receiving an operation input relating to AR information image 1121, HMI controller 640 may instruct AR image generator 660 to generate another AR information image 1122 (shown in FIG. 2) including more detailed information about computer 100. User 100 may move control device 700 to let pointer 1172 (shown in FIG. 2) overlap with a Setting option of AR information image 1122 and press a button of control device 700 as an operational input relating to the Setting option of AR information image 1122. According to similar steps described above, HMI controller 640 may instruct AR image generator 660 to generate another AR information image (not shown) including several setting operations for user 100 to select.

HMI controller 640 may also control AR projector 220 through communication unit 640. When HMI controller 640 determines to display an AR image, HMI controller 640 send control signals and/or information about the image to be displayed to AR image generator 660 and AR projector 220. For example, HMI controller 640 may instruct AR projector 220 to display an AR image after AR image generator 660 generates it. HMI controller 640 may send the position and display parameters (e.g., color, brightness, and time length to display) to AR projector 220 through communication unit 654.

Augmented reality (AR) image generator 660 may include any appropriate type of hardware, such as integrated circuits and field programmable gate arrays, or software, such as a set of instructions, a subroutine, or a function (i.e. a functional program) executable on a processor or controller, to carry out the following AR image generation for intuitive operations through augmented reality. After receiving instructions from HMI controller 640, AR image generator 660 may generate AR information images to be displayed by HMD 200. AR image generator 660 may obtain the images, positions of target apparatus units, and/or identity information about target apparatus units from image processing unit 500 through communication unit 652. AR image generator 660 may identify the position where AR information will be projected on through HMD 200 based on the received images and positions of target apparatus units. For example, as shown in FIG. 1 or 6, when AR image generator 660 receives the images and the positions of computer 110 thereof, AR image generator 660 may identify a position at computer's right-hand upper corner as the position where AR information is going to be projected.

In some embodiments, AR image generator 660 may obtain information about the identified target apparatus from database 620. After receiving the instructions from HMI controller 640 and the identity of the target apparatus, AR image generator 660 may query database 620 for the information about the target apparatus according to HMI controller 640's instructions. After receiving such information about the target apparatus, AR image generator 660 may generate one or more AR information images accordingly and send to AR projector 220 through communication unit 653.

Communication units 651, 652, 653, and 654 may respectively include any appropriate type of hardware, such as integrated circuits and field programmable gate arrays, or software, such as a set of instructions, a subroutine, or a function (i.e. a functional program) executable on a processor or controller, to carry out the following communication operations. In some embodiments, communication units 651, 652, 653, and 654 may be assembled as one or more communication units that respectively include any appropriate type of hardware, such as integrated circuits and field programmable gate arrays, or software, such as a set of instructions, a subroutine, or a function (i.e. a functional program) executable on a processor or controller, to carry out the following communication operations.

For example, communication units 651, 652, 653, and 654 in FIG. 8 may be implemented as an communication unit 650 (not shown) that includes any appropriate type of hardware, such as integrated circuits and field programmable gate arrays, or software, such as a set of instructions, a subroutine, or a function (i.e. a functional program) executable on a processor or controller, to carry out the following communication operations. Throughout the whole disclosure, communication unit 650 may be considered as an alternative to communication units 651, 652, 653, 654, or any combination thereof to carry out their communication operations, and vice versa.

Communication unit 650, or each of communication units 651, 652, 653 and 654 may include modulation and demodulation subunits (i.e. a modem) that modulate and demodulate electric or radio signals for data transmission and reception. For example, communication unit 650 or 651 may include a Wi-Fi modem that receives status information about computer 110 from computer 110 through a Wi-Fi Direct technology. For another example, communication unit 650 or 652 may include a Wi-Fi modem that receives the identity and the position of the target apparatus from image processing unit 500 through a Wi-Fi Direct technology.

For another example, communication unit 650 or 653 may include an LTE modem that transmits AR images to AR projector 220 through an LTE Device-to-Device technology. AR projector 220 receives those AR images through communication unit 250. For another example, communication unit 650 or 654 may include an LTE modem that transmits and receives control signals to and from AR projector 220 through an LTE Device-to-Device technology. AR projector 220 receives and transmits those control signals through communication unit 250.

In some embodiments, communication unit 650, or communication units 651, 652, 653, 654 may include a Wi-Fi modem that transmits and receives the above-mentioned signals and/or data to and from Wi-Fi access point 820 or 840. Access point 820 or 840 may be connected any one of the system's apparatus units and the real-world apparatus units in FIG. 1 and assist signal and data transmissions between these apparatus units. In some embodiments, communication unit 650, or communication units 651, 652, 653, 654 may include a modem for wired communications, such as Ethernet, USB, IEEE 1394, and Thunderbolt while the connection between these apparatus units in FIG. 1 are through these wired lines.

Communication unit 650, or communication units 651, 652, 653, and 654 in FIG. 8, performs the communication operations between control center 600 and all apparatus units shown in FIG. 1. Control center 600 may obtain operational status, parameters, and results of these apparatus units, especially target apparatus units, and store these operational status, parameters, and results in database 620. In addition, communication unit 650, or one of communication units 651, 652, 653, and 654 in FIG. 8, may perform the communication operations between control center 600 and image processing unit 500. Control center 600 may receive real-time identities and positions of target apparatus units from image processing unit 500 through communication unit 650 or 652, look up information about the target apparatus units in database 620, and send the information and the position of the target apparatus units to AR image generator 660. In some embodiments, control center 600 may receive real-time identities and positions of control device 700 from image processing unit 500 through communication unit 650 or 652, and send the identity and position of control device 700 to HMI controller 640.

Moreover, communication unit 650, or one of communication units 651, 652, 653, and 654 in FIG. 8, may perform the communication operations between control center 600 and HMD 200. Control center 600 may determine which information about target apparatus units to be displayed, and send the corresponding AR information images, generated by AR image generator 660, to HMD 200 through communication unit 650 or 653. In some embodiments, control center 600 may display an operational result of an operational input. For example, after HMI controller 640 determines the operation result of an operational input from user 100, control center 600 may send an AR image, generated by AR image generator 660, indicating the operational result to AR projector 220 of HMD 200 through communication unit 650 or 653.

Furthermore, communication unit 650, or one of communication units 651, 652, 653, and 654 in FIG. 8, may perform the communication operations between control center 600 and target apparatus units. Control center 600 may receive user's operational input to a target apparatus, and send a corresponding signal including the operational input to the target apparatus through communication unit 650 or 651. For example, control center 600 may receive an operational input to turn off power of computer 110, and send a signal including an instruction of power off to computer 110 through communication unit 650 or 651.

In addition, FIG. 8 illustrates signal and data flows in an exemplary system architecture for intuitive operations through augmented reality, according to a disclosed embodiment. Camera 400 captures images of a real-world environment, including indicator signals, and sends these images to image processing unit 500. Image processing unit 500 identifies and detects identities and positions of target apparatus units and sends them to control center 600 and/or AR projector 220 of HMD 200. Control center 600 looks up information about the identified target apparatus units, generator AR information images, and provides them to AR projector 220 of HMD 200. User 100 sees the AR images augmented to the identified target apparatus, for example, computer 110, in the real-world environment.

User 100 may further move control device 700 to let its AR pointer overlap with AR information image 112 and press a button of control device 700 as an operational input to computer 110. Camera 400 captures indicator signals from control device 700, and sends these signals to image processing unit 500. Image processing unit 500 identifies and detects the identity and position of control device 700 and sends them to control center 600 and/or AR projector 220 of HMD 200. Control center 600 associates the operational input with computer 110 after determining the AR pointer of control device 700 being overlapped with AR information image 112 at the time of receiving the operational input. Control center 600 sends a signal including the operational input to computer 110 and sends an AR image of an operational result to AR projector 220 of HMD 200. User 100 then sees the operational result through the AR image augmented to the identified target apparatus, for example, computer 110, in the real-world environment.

In some embodiments, database 620, HMI controller 640, and/or AR image generator 660 of control center 600 may be carried out as single central controller 600 or several individual apparatus units. For example, a HMI control apparatus includes HMI controller 640 and communication unit 652, an AR image generation apparatus includes AR image generator 660 and communication unit 653, and a database apparatus includes database 620 and communication unit 651. In some embodiments, image processing unit 500 may be integrated into control center 600.

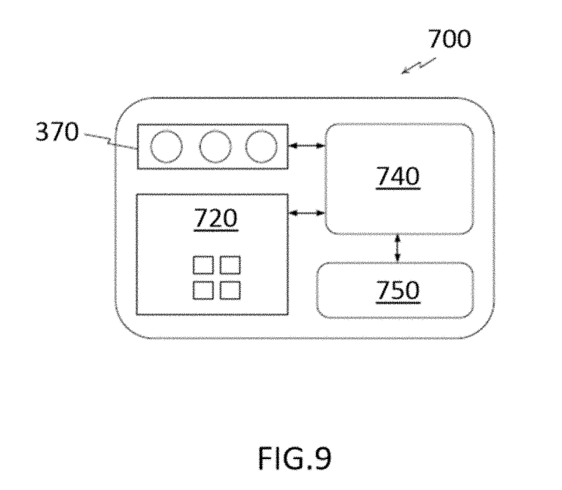

FIG. 9 is an exemplary control device 700 for intuitive operations through augmented reality, according to a disclosed embodiment. Control device 700 includes an identity indicator 370, user input devices such as input buttons 720, a control device controller 740, and a communication unit 750. Identity indication 370 is an embodiment of identity indication 300 and its structure and functions are similar to that of identity indicator 300. Input buttons 720 may include physical buttons, touch buttons, virtual buttons on a touchscreen, or any combination thereof. When a user press or touch one of input buttons 720, it sends a corresponding signal to control device controller 740 as an operational input. In some embodiments, control device 700 may include a voice recognition unit, to allow voice inputs from user 100.

Control device controller 740 may include any appropriate type of hardware, such as integrated circuits and field programmable gate arrays, or software, such as a set of instructions, a subroutine, or a function (i.e. a functional program) executable on a processor or controller, to carry out the following control operations for control device 700. Control device controller 740 controls identity indicator 370 to send light signals associated with the unique identity of control device 700. Control device controller 740 also receives an input signal from one of input buttons 720 and sends a signal corresponding to the pressed or touched one of input buttons 720 as an operational input to HMD 200 and/or control center 600 through communication unit 750.

Communication unit 750 may include any appropriate type of hardware, such as integrated circuits and field programmable gate arrays, or software, such as a set of instructions, a subroutine, or a function (i.e. a functional program) executable on a processor or controller, to carry out the following communication operations. Communication unit 750 includes modulation and demodulation subunits (i.e. a modem) that modulate and demodulate electric or radio signals for data transmission and reception. For example, communication unit 750 may include a Wi-Fi modem that transmits a signal including an operational input to HMD 200 and/or control center 600 through a Wi-Fi Direct technology.

For another example, communication unit 750 may include an LTE modem that receives an assigned identity for control device 700 from control center 600 through an LTE Device-to-Device technology. For another example, communication unit 750 may include a Wi-Fi modem that receives identity data, transmitted by control center 600, from Wi-Fi access point 820 or 840. Access point 820 or 840 may be wirelessly connected control center 600. In some embodiments, communication unit 750 may include a modem for wired communications, such as Ethernet, USB, IEEE 1394, and Thunderbolt while the connection between control device 700 and HMD 200 or control center 600 is through one of these wired lines.

Another aspect of the present disclosure is directed to a method for intuitive operations through augmented reality performed by one or more integrated circuits, one or more field programmable gate arrays, one or more processors or controllers executing instructions that implement the method, or any combination thereof. The method may include, but is not limited to, all the aforementioned methods and embodiments and the methods and embodiments presented in the following. In some embodiments, a part of steps in the aforementioned methods or embodiments may be performed remotely or separately. In some embodiments, the method may be performed by one or more distributed systems.

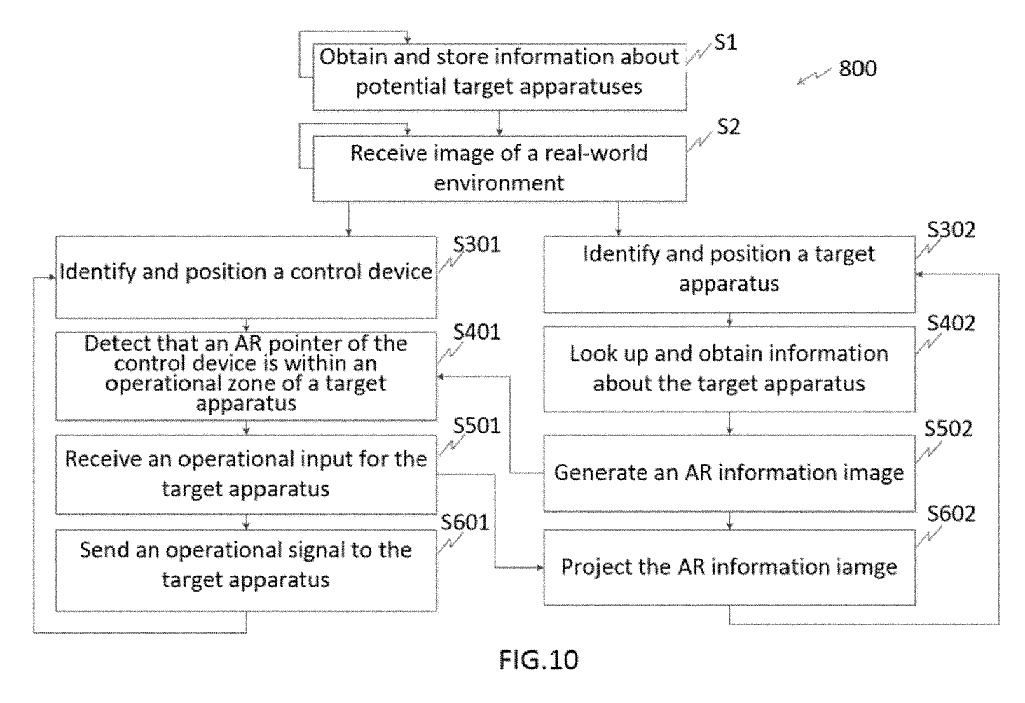

FIG. 10 is a flow chart illustrating an exemplary method 800 for intuitive operations through augmented reality, according to a disclosed embodiment. Method 800 includes obtaining and storing information about potential target apparatus units (step S1), receiving images of a real-world environment (step S2), identifying and positioning a control device (step S301), detecting that an AR pointer of the control device is within an operational zone of a target apparatus (step S401), receiving an operational input for the target apparatus (step S501), sending an operational signal to the target apparatus (step S601), identifying and positioning a target apparatus (step S302), looking up and obtaining information about the target apparatus (step S402), generating an AR image (step S502), and projecting the AR image (step S602).

Step S1 includes obtaining and storing information about potential target apparatus units (i.e. those real-world apparatus units connected and controlled by control center 600). For example, obtaining status information about potential target apparatus units in step S1 may include querying and receiving information about potential target apparatus units from them in an initialization process and a regular or event-driven reporting process. In the initialization process, control center 600 may query information about potential target apparatus units that are going to be connected to control center 600 and under control of control center 600. Those potential target apparatus units may provide the information automatically or after receiving a query from control center 600 during the initialization process.

The information may include descriptive information, status information, operational information, and setting information about potential target apparatus units. In a regular reporting process, those potential target apparatus units connected to control center 600 may regularly report their latest information in a period of time. For example, a target apparatus may regularly report its information every 30 minutes. In the event-driven reporting process, those potential target apparatus units may report their updated information once there is any information should be updated. For example, computer 110 may report that it has completed a task after receiving the operational input from user 100. Control center 600 may generate an AR information image including the information about the completed task and control HMD 200 to display the AR information image.

Storing information about potential target apparatus units in step S1 may include, for example, storing the above-mentioned information into database 620 of control center 600. In some embodiments, to achieve quick response for user experience, control center 600 may retain all information about potential target apparatus units in its database 620. Status information about operations of potential target apparatus units may be updated by an event-driven process to keep real-time information available for users.

Step S2 includes receiving images of a real-world environment. When a user puts on HMD 200 and starts to look around a real-world environment, receiving images of a real-world environment in step S2 may include receiving images of the real-world environment from camera 400 of HMD 200. When there are potential target apparatus units in the real-world environment, receiving images of a real-world environment in step S2 may also include receiving indicator signals from identity indicators of those potential target apparatus units. Method 800 may continuously perform step S2 after user 100 starts to look around the real-world environment through HMD 200.

After receiving images of the real-world environment, method 800 includes two sets of steps to identify and interact in augmented reality with a target apparatus and a control device respectively. To identify and interact in augmented reality with a target apparatus, method 800 includes identifying and positioning the target apparatus (step S302), looking up and obtaining information about the target apparatus (step S402), generating an AR image (step S502), and projecting the AR image (step S602).

Step S302 includes identifying and positioning the target apparatus. For example, identifying the target apparatus in step S302 may include receiving an indicator signal from an apparatus and determining the apparatus as the target apparatus according to the received indicator signal. As described above, a target apparatus includes an identity indicator that regularly sends a unique indicator signal through its indicator lights. Identifying the target apparatus in step S302 may include receiving such indicator signal from an apparatus and determining the apparatus as the target apparatus when the indicator signal matches that of one of potential target apparatus units. An indicator signal may include one or more light signals from the indicator lights of the apparatus, for example, indicator lights 321, 322, 323 shown in FIG. 4. An indicator signal may also include one or more flash rates of the one or more light signals. An indicator signal may further include one or more wavelengths of the one or more light signals.

In some embodiments, determining the apparatus as the target apparatus in step S302 may include sending a signal for identifying the apparatus to an image processing unit or a control center, and receiving a signal identifying the apparatus as the target apparatus from the image processing unit or the control center. The signal for identifying the apparatus includes the received indicator signal, such as the number of indicator lights, flash rates of the received light signals, and wavelengths of the received light signals. After receiving such signal for identifying the apparatus, the image processing unit or the control center may compare the received indicator signal and that of potential target apparatus units in its memory or database. When the received indicator signal matches that of one of potential target apparatus units, the control center or the image processing unit may send the signal identifying the one as the target apparatus. Determining the apparatus as the target apparatus in step S302 includes receiving the signal identifying the apparatus as the target apparatus from the control center or the image processing unit.

In some embodiments, determining the apparatus as the target apparatus in step 302 may further include receiving information about the target apparatus from the control center. For example, after identifying computer 110 as the target apparatus, control center 600 may also send information about computer 110 in its database 620 for displaying to user 100. Determining the apparatus as the target apparatus in step 302 may include receiving such information about computer 110 from control center 600.

Positioning the target apparatus in step S302 may include identifying the position of the target apparatus on one or more images containing the target apparatus based on the received indicator signal. While identifying the identity based on the indicator signal, the position of the indicator signal on the received images may be used to find at least a rough position of the target apparatus on the images because the indicator signal is sent from the identity indicator of the target apparatus. Accordingly, positioning the target apparatus in step S302 may include finding a rough position of the target apparatus on the received images based on the position of the indicator signal on the received images.

In some embodiments, positioning the target apparatus in step S302 may also include matching a template image of the target apparatus and the received images of the real-world environment. The template image of the target apparatus is available because the target apparatus has been identified. Accordingly positioning the target apparatus in step 302 may include identifying the position of the target apparatus on the images containing the target apparatus based on the indicator signal.

Step S402 includes looking up and obtaining information about the target apparatus. For example, looking up information about the target apparatus may include looking up information about the target apparatus in database 620 of control center 600 based on the identity obtained in step S302. Once the target apparatus is found in database 620, the target apparatus is recognized as one of potential target apparatus units under control of control center 600. After finding the target apparatus in database 620, obtaining information about the target apparatus in step S402 may also include querying and obtaining information about the identified target apparatus from database 620. The information about the target apparatus includes descriptive information, status information, operational information, or setting information about the target apparatus, or any combination thereof.

Step S502 includes generating an AR image. For example, after obtaining information about the target apparatus, generating the AR image in step S502 may include generating an AR image that displaying the obtained information. For example, generating the AR image in step S502 may include generating AR information images 112 and 122 for computer 110 and printer 120 respectively, as shown in FIG. 1. In some embodiments, generating the AR image in step S502 may also include generating an AR image displaying the operational result after receiving an operational input. For example, generating the AR image in step S502 may include generating AR information image 1122 after receiving the operational input to computer 110, as shown in FIG. 2.

Step S602 includes projecting the AR image. For example, projecting the AR image in step S602 may include projecting the generated AR information image in step S502 at a fixed position of beam splitter 240. For example, projecting the AR image in step S602 may include projecting AR information image 112 at a right-hand upper corner of beam splitter 240 (not shown). In some embodiments, projecting the AR image in step S602 may include projecting the generated AR information image in step S502 at the position of the target apparatus. For example, projecting the AR image in step S602 may include projecting AR information image 112 at the upper right-hand position of computer 110 (not shown). Projecting the AR image in step S602 may also include iteratively projecting AR information image 112 at updated right-hand upper positions of computer 110 since AR images are always projected on beam splitter 240 of HMD 200 and the target apparatus may be located at different positions on beam splitter 240 when user 100 moves around or turns around his head.

In some embodiments, projecting the AR image in step S602 may include projecting the generated AR information image in step S502 at a position adjacent to the position of the target apparatus. For example, projecting the AR image in step S602 may include projecting AR information image 112 at an upper right-hand position adjacent to the position of computer 110, as shown in FIG. 1. Projecting the AR image in step S602 may also include iteratively projecting AR information image 112 at updated right-hand upper positions adjacent to the updated positions of computer 110 since AR images are always projected on beam splitter 240 of HMD 200 and the target apparatus, computer 110 may be located at different positions on beam splitter 240 when user 100 moves around or turns around his head.

To identify and interact in augmented reality with a control device, method 800 includes identifying and positioning the control device (step S301), detecting that the control device is within an operational zone of a target apparatus (step S401), receiving an operational input (step S501), and sending an operational signal to the target apparatus (step S601).

Step S301 includes identifying and positioning the control device. For example, identifying the control device in step S301 may include receiving an indicator signal from an apparatus and determining the apparatus as control device 700 according to the received indicator signal. As described above, a control device, similar to a target apparatus, includes an identity indicator that regularly sends a unique indicator signal through its indicator lights. Identifying the control device in step S301 may include receiving such indicator signal from an apparatus and determining the apparatus as the control device when the indicator signal matches that of one of control devices. An indicator signal may include one or more light signals from the indicator lights of the control device, for example, indicator lights 321, 322, 323 shown in FIG. 4. An indicator signal may also include one or more flash rates of the one or more light signals. An indicator signal may further include one or more wavelengths of the one or more light signals.

In some embodiments, determining the apparatus as the control device in step S301 may include sending a signal for identifying the apparatus to an image processing unit or a control center, and receiving a signal identifying the apparatus as the control device from the image processing unit or the control center. The signal for identifying the apparatus includes the received indicator signal, such as the number of indicator lights, flash rates of the received light signals, and wavelengths of the received light signals. After receiving such signal for identifying the apparatus, the image processing unit or the control center may compare the received indicator signal and that of potential control devices as well as target apparatus units in its memory or database. When the received indicator signal matches one of control devices, the control center or the image processing unit may send the signal identifying the apparatus as the control device. Determining the apparatus as the control device in step S301 includes receiving the signal identifying the apparatus as the control device from the control center or the image processing unit.

In some embodiments, determining the apparatus as the control device in step 301 may further include receiving information about the control device from the control center. For example, after identifying control device 700 as the control device, control center 600 may also send information about control device 700 in its database 620 for displaying to user 100. Determining the apparatus as the control device in step 302 may include receiving such information about control device 700 from control center 600.

Positioning the control device in step S301 may include identifying the position of the control device on one or more images containing the control device based on the received indicator signal. While identifying the identity based on the indicator signal, the position of the indicator signal on the received images may be used to find at least a rough position of the control device on the images because the indicator signal is sent from the identity indicator of the control device. Accordingly, positioning the control device in step S302 may include finding a rough position of the control device on the received images based on the position of the indicator signal on the received images.

In some embodiments, positioning the control device in step S301 may also include matching a template image of the control device and the received images of the real-world environment. The template image of the control device is available because the control device has been identified. Accordingly, positioning the target apparatus in step 301 may include identifying the position of the control device on the images containing the control device based on the indicator signal.

Step S401 includes detecting that an AR pointer of the control device is within an operational zone of a target apparatus. For example, detecting that the AR pointer of the control device is within the operational zone of the target apparatus in step S401 may include detecting whether AR pointer 1171 of control device 700 is within the operational zone of computer 110. An operational zone of a target apparatus is defined as a region, by seeing through beam splitter 240 of HMD 200, where a control device can point to and send an operational input to the target apparatus when a user presses a button of the control device. The operational zone of the target apparatus may include a region of the AR information image. For example, the operational zone of computer 110 in FIG. 1 may include the region of AR information image 112 while seeing through beam splitter 240.

In some embodiments, the operational zone of the target apparatus may include a region of the target apparatus. For example, the operational zone of printer 120 in FIG. 1 may include the region of printer 120 while seeing through beam splitter 240. In some embodiments, the operational zone of the target apparatus may include a region of the target apparatus and its AR information image. For example, the operational zone of computer 110 in FIG. 1 may include the region of computer 110 and AR information image 112 while seeing through beam splitter 240. In some embodiments, the operational zone of the target apparatus may include a region at a fixed position. For example, the operational zone of computer 110 in FIG. 1 may include the region at the right-hand upper corner while seeing through beam splitter 240. In some embodiments, the operational zone of the target apparatus may include a region of any combination of the above-mentioned regions.

Detecting whether control device 700 is within the operational zone of computer 110 may include detecting the position of control device 700 and determining whether the detected position of control device 700 is within the operational zone of computer 110. Positions of target apparatus units, control devices, and AR information images in augmented reality may all be recorded by their coordinates. After detecting the position of control device 700, detecting that the AR pointer of the control device is within the operational zone of the target apparatus in step S401 may include comparing the coordinates of control device 700 and the operational zone of computer 110, and determining whether control device 700 is within the operational zone of computer 110 accordingly.

In some embodiments, an operational zone may include one or more operational sub-zones corresponding to the one or more detailed information about the target apparatus units. For example, while AR information image 1122 is considered as the operational zone of computer 110 in FIG. 2, Status, Operations, and Setting sub-regions of AR information image 1122 are three operational sub-zones that may be pointed to by AR pointer 1172. User 100 may send an input signal for one of the three information options corresponding to the pointed operational sub-zone by control device 700. Detecting AR pointer 1172 and receiving the input signal to one of operational sub-zones are similar to the above operations for the operational zone.

Step S501 includes receiving an operational input for the target apparatus. For example, receiving the operational input for the target apparatus in step S501 may include receiving an input signal from control device 700, and determining the input signal is for computer 110 when AR pointer 1171 is within the operational zone of computer 110, i.e. the region of AR information image 1121, as shown in FIG. 2. In some embodiments, receiving the operational input for the target apparatus in step S501 may include receiving an input signal at control device 700 when user 100 presses one of buttons 720. The input timing of the input signal and/or the position of AR pointer 1171 at the instance of receiving the input signal may be used in S401 to detect that control device 700 or its AR pointer 1171 is within the region of AR information image 1121, the operational zone of computer 110. Receiving the operational input for the target apparatus in S501 may include determining the input signal is for computer 110 when AR pointer 1171 overlaps AR information image 1121.

Step S601 includes sending an operational signal to the target apparatus. For example, sending the operational signal to the target apparatus in step S601 may include sending an operational signal to control center, to request an operation of the target apparatus corresponding to the operational input. For example, sending the operational signal to the target apparatus in step S601 may including sending an operational signal to request computer 110 to run a task. After receiving the operation input from control device 700, control center 600 may send the operational signal including the instruction to run the task to computer 100.

Yet another aspect of the present disclosure is directed to a non-transitory computer-readable medium storing instructions which, when executed, cause at least one processor to perform operations for intuitive operations through augmented reality. The operations may include, but not limited to, all the aforementioned methods and embodiments. In some embodiments, a part of steps in the aforementioned methods or embodiments may be performed remotely or separately. In some embodiments, the operations may be performed by one or more distributed systems.

It will be apparent to those skilled in the art that various modifications and variations can be made to the disclosed systems and methods for intuitive operations in augmented reality. Other embodiments will be apparent to those skilled in the art from consideration of the specification and practice of the disclosed systems and methods for intuitive operations in augmented reality. It is intended that the specification and examples be considered as exemplary only, with a true scope being indicated by the following claims and their equivalents.

What is claimed is:

1. A system for operating an apparatus through augmented reality (AR), the system comprising:
an image capture unit that captures an image of a real-world environment of a user;
an image processing unit that processes the captured image to identify a target apparatus;
a display, adapted for viewing by the user, that displays to the user an AR information image for the target apparatus;
a control device that receives from the user an operational input for the target apparatus and transmits the operational input; and
a control center that receives the transmitted operational input and sends an operational signal to the target apparatus.

2. The system of claim 1, wherein the captured image comprises an image of a real-world apparatus, the real-world apparatus comprises an identity indicator providing an indicator signal, the image processing unit determines the real-world apparatus to be the target apparatus based on the received indicator signal, the indicator signal comprises at least one of the following information:
a light signal from an indicator light of the real world apparatus;
a flash rate of the light signal; or
a wavelength of the light signal.

3. The system of claim 2, wherein the image processing unit comprises an identity detection module configured for receiving the captured image to identify the identity of the identity indicator according to the indicator signal transmitted from the identity indicator.

4. The system of claim 3, wherein the image processing unit is communicatively connected to the control center so as to receive information about the target apparatus from the control center, the information about the target apparatus comprises at least one of:
descriptive information about the target apparatus;
status information about the target apparatus;
operational information about the target apparatus; or
setting information about the target apparatus.

5. The system of claim 3, wherein the image processing unit further comprises a coordinate calculation module configured for determining a position of the target apparatus based on the indicator signal.

6. The system of claim 1, wherein the display is a head-mounted display, the head-mounted display comprises an AR projector and a beam splitter, the AR projector is configured for projecting the AR information image on the beam splitter for the user, the head-mounted display is communicatively connected to the image capture unit, the image processing unit and the control center.

7. The system of claim 1, wherein the control device comprises:
a user input device for generating an input signal; and
a control device controller for receiving the input signal and determining the input signal is for the target apparatus when the image processing unit detects that an AR pointer of the control device is within an operational zone of the target apparatus, the operational zone of the target apparatus comprises at least one of:
a region of the AR information image as seen by the user through the beam splitter;
a region of the target apparatus as seen by the user through the beam splitter; or
a fixed region as seen by the user through the beam splitter.

8. The system of claim 1, wherein the control center is communicatively connected to the target apparatus, the image processing unit, and the display, and the control center comprises:
a database for storing information about the target apparatus;
a human-machine interaction controller for controlling the interactions between the user and the displayed AR information image;
an augmented reality image generator for generating the displayed AR information image.

9. The system of claim 1, wherein:
the AR information image is a first AR information image;
the operational input is a first operational input;
the operational signal is a first operation signal;
the display displays a second AR information image for the target apparatus after receiving the first operational input;
the control device receives from the user a second operational input for the target apparatus and transmits the second operational input;
the control center receives the transmitted second operational input and sends a second operational signal to the target apparatus; and
the second AR information image contains information corresponding to the first operational input.

10. The system of claim 9, wherein:
the second AR information image comprises an operational sub-zone corresponding to detailed information about the target apparatus; and
the control device receives the second operational input for the target apparatus by:
receiving an input signal from the control device when the image processing unit detects that an AR pointer of the control device is within the operational sub-zone.

11. A method for operating an apparatus through augmented reality (AR), the method comprising:
obtaining an image of a real-world environment;
identifying a target apparatus in the obtained image;
displaying, to a user, an AR information image for the target apparatus;
receiving an operational input for the target apparatus; and
sending an operational signal to the target apparatus.

12. The method of claim 11, wherein identifying the target apparatus comprises:
receiving an indicator signal from a real-world apparatus; and
based on the received indicator signal, determining the real-world apparatus to be the target apparatus, the indicator signal comprises at least one of the following information:
a light signal from an indicator light of the real-world apparatus;
a flash rates of the light signal; or
a wavelength of the light signal.

13. The method of claim 12, wherein determining the real-world apparatus to be the target apparatus comprises:
sending, to a control center, a signal for identifying the real-world apparatus, the signal for identifying the real-world apparatus comprising information contained in the indicator signal; and
receiving, from the control center, a signal identifying the real-world apparatus as the target apparatus.

14. The method of claim 13, wherein determining the real-world apparatus to be the target apparatus further comprises receiving information about the target apparatus from the control center, the information about the target apparatus comprises at least one of:
descriptive information about the target apparatus;
status information about the target apparatus;
operational information about the target apparatus; or
setting information about the target apparatus.

15. The method of claim 12, further comprising identifying a position of the target apparatus based on the indicator signal, wherein displaying the AR information image comprises at least one of:
projecting the AR information image at a fixed position on a beam splitter;
projecting the AR information image at the position of the target apparatus on the beam splitter; or
projecting the AR information image at a position adjacent to the position of the target apparatus on the beam splitter.

16. The method of claim 11, wherein receiving the operational input for the target apparatus comprises:
detecting that an AR pointer of a control device is within an operational zone of the target apparatus; and
receiving an input signal from the control device;
wherein the operational zone of the target apparatus comprises at least one of:
a region of the AR information image as seen by the user through the beam splitter;
a region of the target apparatus as seen by the user through the beam splitter; or
a fixed region as seen by the user through the beam splitter.

17. The method of claim 11, wherein sending the operational signal to the target apparatus comprises sending the operational signal to the target apparatus to request an operation of the target apparatus, the operation corresponding to the received operational input.

18. The method of claim 11, wherein:
the AR information image is a first AR information image;
the operational input is a first operational input;
the operational signal is a first operation signal;
the method further comprises:
displaying, to the user, a second AR information image for the target apparatus after receiving the first operational input;
receiving a second operational input for the target apparatus; and
sending a second operational signal to the target apparatus; and
the second AR information image contains information corresponding to the first operational input.

19. The method of claim 18, wherein:
the second AR information image comprises an operational sub-zone corresponding to detailed information about the target apparatus; and
receiving the second operational input for the target apparatus comprises:
detecting that the AR pointer of the control device is within the operational sub-zone; and
receiving an input signal from the control device.

20. A non-transitory computer-readable medium storing instructions which, when executed, because at least one processor to perform operations for operating an apparatus through augmented reality (AR), the operations comprising:
obtaining an image of a real-world environment;
identifying a target apparatus in the obtained image;
displaying, to a user, an AR information image for the target apparatus;
receiving an operational input for the target apparatus; and
sending an operational signal to the target apparatus.
